(19) United States
(12) Patent Application Publication
(10) Pub. No.: US 2007/0139324 A1
(43) Pub. Date: Jun. 21, 2007

(54) Transflective liquid crystal display and method for adjusting gamma setting thereof

(75) Inventors: Yi-Chang Lai, Miao-Li (TW); Chien-Jen Chang, Miao-Li (TW); Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/641,979

(22) Filed: Dec. 19, 2006

(30) Foreign Application Priority Data
Dec. 21, 2005 (CN) 200510121022.4

(51) Int. Cl. G09G 3/36

(52) U.S. Cl. 345/87

(57) ABSTRACT

An exemplary liquid crystal display device (200) includes a transflective liquid crystal display panel (210) having a first substrate (212), a second substrate (214), and a liquid crystal layer (213) disposed between the first and second substrates. The second substrate includes an integrated circuit (28). The integrated circuit includes a source driving circuit (33) and a gamma setting adjusting unit (31 and 32) coupled to the source driving circuit. A method of adjusting a gamma setting of a liquid crystal display device is also provided.

### FIELD OF THE INVENTION

The present invention relates to liquid crystal displays (LCDs), and especially to a transflective liquid crystal display and a method of adjusting the gamma setting of the transflective liquid crystal display.

### BACKGROUND

LCD devices have the advantages of portability, low power consumption, and low radiation, and because of this they have been widely used in various portable information products such as notebooks, personal digital assistants (PDAs), video cameras, and the like. Furthermore, LCD devices are considered by some to have the potential to completely replace CRT (cathode ray tube) monitors and televisions.

Referring to FIG. 4, a schematic, side-on view of a conventional transflective LCD device is shown. The transflective LCD device 100 includes a transflective LCD panel 110, and a backlight module 120 disposed below the transflective LCD panel 110.

The transflective LCD panel 110 includes a first polarizer 111, a first substrate assembly 112, a liquid crystal layer 113, a second substrate assembly 114, and a second polarizer 115 disposed from top to bottom in that order. The first substrate assembly 112 includes a transparent substrate 11 and a color filter 12 disposed under the transparent substrate 11. The second substrate assembly 114 includes a transparent substrate 16 and an electrode layer 15 disposed on the transparent substrate 16, and the electrode layer 15 includes a plurality of reflection electrodes 13 and transmission electrodes 14 arranged in alternating fashion. The liquid crystal layer 113 is disposed between the color filter 12 and the electrode layer 15, and the whole liquid crystal layer 113 has a constant thickness.

When the transflective LCD device 100 operates in a reflection mode, ambient incident light passes through the first polarizer 111, the transparent substrate 11, the color filter 12, and the liquid crystal layer 113, one after the other in that order and then is incident upon the electrode layer 15. Parts of the ambient incident light is then reflected by the reflection electrode 13 and exits out of the transflective LCD panel 110 through the liquid crystal layer 113, the color filter 12, the transparent substrate 11, and a first polarizer 111 again. When the transflective LCD device 100 operates in transmission mode, the light beams emitted by the backlight module 120 pass through the second polarizer 115, the transparent substrate 16, the transmission electrode 14, the liquid crystal layer 113, the color filter 12, the transparent substrate 11, and the first polarizer 111 one after the other in that order and are then emitted out of the transflective LCD panel 110.

The transflective LCD device 100 includes a gamma setting, which can be represented by a gamma curve showing the relationship between the gamma voltage and the optical transmittance of the liquid crystal molecules. The gamma voltage is the voltage required to induce the liquid crystal molecules to twist. When a gamma voltage is applied to the liquid crystal layer 113, the liquid crystal molecules may ‘twist’, thus allowing a certain quantity of light to pass through the liquid crystal layer 113. This light is then measured and optical transmittance is then determined.

FIG. 5 and FIG. 6 show gamma curves (a T-curve and a R-curve respectively) representing the relationship between the gamma voltage and the optical transmittance when the transflective LCD device 100 operates in an ideal transmission mode (T) and in an ideal reflection mode (R). The X-coordinate represents the gamma voltage, and the Y-coordinate represents the optical transmittance. Comparing the T-curve and the R-curve, it can be seen that the optical transmittance of the transflective LCD device 100 operating in the transmission mode is higher than that of the transflective LCD device 100 operating in the reflection mode. This is because the light beams pass only once through the color filter 12 in the transmission mode, but they pass twice through the color filter 12 in the reflection mode and thus have a high absorption ratio.

However, the transflective LCD device 100 has only one gamma setting. That is, the gamma setting cannot be adjusted according to the operational modes of the transflective LCD device 100 (i.e., transmission or reflection). In FIG. 7, the empirical T-curve and R-curve do not match the ideal curves. Therefore, the transflective LCD device 100 is liable to suffer from distortion, which prevents the transflective LCD device 100 from forming high-quality images.

Accordingly, what is needed is a transflective LCD device that can overcome the above-described deficiencies.

### SUMMARY

An exemplary liquid crystal display device includes a transflective liquid crystal display panel having a first substrate, a second substrate, and a liquid crystal layer disposed between the first and second substrates. The second substrate includes an integrated circuit. The integrated circuit includes a source driving circuit, and a gamma setting adjusting unit coupled to the source driving circuit.

An exemplary method for adjusting gamma setting of a transflective liquid crystal display device includes: providing a transflective liquid crystal display device, the transflective liquid crystal display device including a transflective liquid crystal display panel, a backlight module disposed under the transflective liquid crystal display panel, and a gamma setting adjusting unit coupled to the transflective liquid crystal display panel. The transflective liquid crystal display panel can then be set to a gamma setting corresponding to its current reflection/transmission mode.

Other advantages and novel features will become more apparent from the following detailed description of preferred embodiments when taken in conjunction with the accompanying drawings.

### BRIEF DESCRIPTION OF THE DRAWINGS

FIG. 1 is a schematic, side-on view of a transflective LCD device according to an exemplary embodiment of the present invention.

FIG. 2 is a schematic, top-down view of an integrated circuit employed in the transflective LCD device shown in FIG. 1.

FIG. 3 is a graph showing a relationship between a gamma voltage and an optical transmittance according to the transflective LCD device shown in FIG. 1.

FIG. 4 is a schematic, side-on view of a conventional transflective LCD device.

FIG. 5 is a graph showing an ideal relationship between a gamma voltage and an optical transmittance for the transflective LCD device shown in FIG 4 when operating in a transmission mode.

FIG. 6 is a graph showing an ideal relationship between a gamma voltage and an optical transmittance for the transflective LCD device shown in FIG. 4 when operating in a reflection mode.

FIG. 7 shows two curves R and T representing an empirical relationship between a gamma voltage and an optical transmittance according to the transflective LCD device shown in FIG. 4 when operating in a transmission mode and a reflection mode.

### DETAILED DESCRIPTION OF PREFERRED EMBODIMENTS

Reference will now be made to the drawings to describe the preferred embodiments in detail.

FIG. 1 shows a schematic side-on view of a transflective LCD device according to an exemplary embodiment of the present invention. The transflective LCD device 200 includes a transflective LCD panel 210, and a backlight module 220 disposed at a bottom side of the transflective LCD panel 210.

The transflective LCD panel 210 includes a first polarizer 211, a first substrate assembly 212, a liquid crystal layer 213, a second substrate assembly 214, and a second polarizer 215 arranged from top to bottom in that order. The first substrate assembly 212 includes a transparent substrate 21, a color filter 22, and a common electrode 23 positioned one on top of the other in that order. The second substrate assembly 214 includes a transparent substrate 27 and an electrode layer 26 disposed on the transparent substrate 27, and the electrode layer 26 includes a plurality of reflection electrodes 24 and transmission electrodes 25 disposed in alternating fashion. The liquid crystal layer 213 is disposed between the common electrode 23 and the electrode layer 26, and the liquid crystal layer 213 has a constant thickness. Moreover, an integrated circuit 28 is disposed on a peripheral portion of the transparent substrate 27.

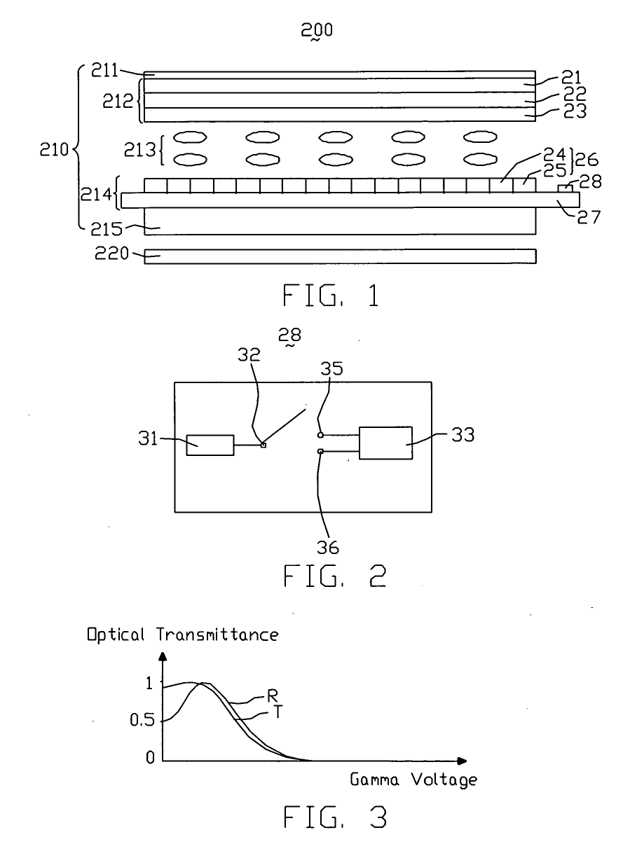

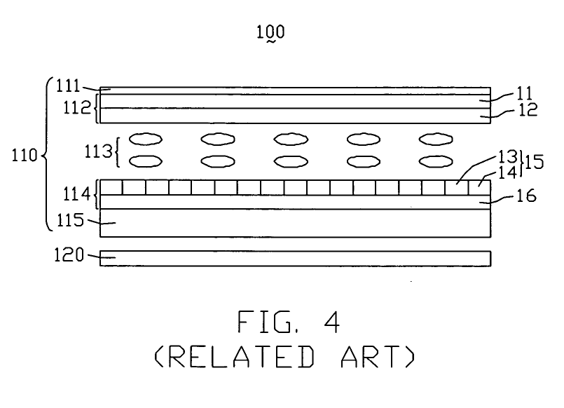

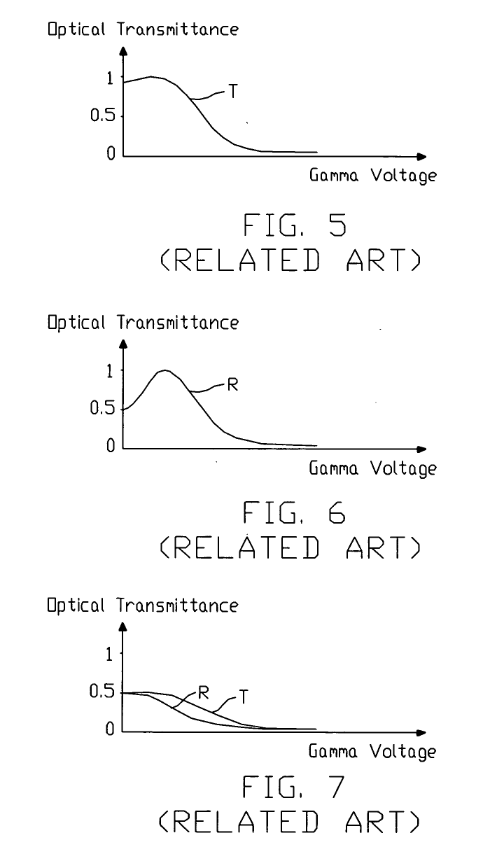

FIG. 2 shows a schematic, top-down view of the integrated circuit 28. The integrated circuit 28 includes a source driving circuit 33, a brightness sensor 31, and a switch 32. The brightness sensor 31 is connected to the switch 32 to form a unit for adjusting gamma settings. The source driving circuit 33 includes a first terminal 35 and a second terminal 36 each corresponding to a different gamma setting of the transflective LCD device 200. The gamma settings can include a reflection mode and a transmission mode for the transflective LCD device 200.

When the transflective LCD device 200 operates in reflection mode, the brightness sensor 31 cannot detect light emitted by the backlight module 220, the switch 32 will then connect with the second terminal 36 of the source driving circuit 33 to switch the transflective LCD device 200 to a gamma setting matching the reflection mode. The ambient incident light passes through the first polarizer 211, the transparent substrate 21, the color filter 22, the common electrode 23, and the liquid crystal layer 213 one after the other in that order and is then incident upon the electrode layer 26. Part of the incident ambient light is reflected by the reflection electrode 24 and exits out of the transflective LCD panel 210, passing through the liquid crystal layer 213, the common electrode 23, the color filter 22, and the transparent substrate 21, and the first polarizer 211 again.

When the LCD device 200 operates in a transmission mode, the brightness sensor 31 can detect light emitted by the backlight module 220, the switch 32 can then connect to the first terminal 35 of the source driving circuit 33 to switch the transflective LCD device 200 to a gamma setting matching with the transmission mode. The light emitted by the backlight module 220 passes through the second polarizer 215, the transparent substrate 27, the transmission electrode 25, the liquid crystal layer 213, the common electrode 23, the color filter 22, the transparent substrate 21, and the first polarizer 211 one after the other in that order and is then emitted out of the transflective LCD panel 210.

In FIG. 3, a graph showing a relationship between gamma voltage and optical transmittance for the transflective LCD device 200 is shown. The X-coordinate represents the gamma voltage, and the Y-coordinate represents the optical transmittance. Both the empirical T-curve and R-curve match with the ideal curves.

With this configuration, because the transflective LCD device 200 can switch between gamma settings according to operational modes, the real-life T-curve and R-curve match the ideal curves. Therefore, it can prevent the transflective LCD device 200 from generating distortion, thus ensuring that the transflective LCD device 200 can form high-quality images.

In additional, the gamma settings for an LCD device are not limited to a single reflection mode and a single transmission mode for a transflective LCD device and may include many different modes, thus giving the LCD device a plurality of display modes.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A transflective liquid crystal display device, comprising:
a transflective liquid crystal display panel comprising a first substrate, a second substrate, and a liquid crystal layer disposed between the first and second substrates, the second substrate comprising at least one integrated circuit;
wherein the at least one integrated circuit comprises a source driving circuit and a gamma setting adjusting unit coupled to the source driving circuit.

2. The transflective liquid crystal display device as claimed in claim 1, wherein the gamma setting adjusting unit comprises a brightness sensor and a switch, the switch being capable of changing the gamma setting according a brightness level detected by the brightness sensor.

3. The transflective liquid crystal display device as claimed in claim 2, wherein the liquid crystal layer has a constant thickness.

4. The transflective liquid crystal display device as claimed in claim 3, wherein the transflective liquid crystal display device comprises two gamma settings corresponding to a reflection mode and a transmission mode of the transflective liquid crystal display device.

5. The transflective liquid crystal display device as claimed in claim 3, wherein the transflective liquid crystal display device comprises a plurality of gamma settings.

6. A method for adjusting one or more gammas setting of a transflective liquid crystal display device, the method comprising:
providing a transflective liquid crystal display device, the transflective liquid crystal display device comprising a transflective liquid crystal display panel, a backlight module disposed under the transflective liquid crystal display panel, and a gamma setting adjusting unit coupled to the transflective liquid crystal display panel;
adjusting the transflective liquid crystal display panel to a gamma setting according to a reflection mode thereof, and or adjusting the transflective liquid crystal panel to another gamma setting according a transmission mode thereof.

7. The method as claimed in claim 6, wherein the gamma setting adjusting unit comprises a brightness sensor and a switch, the switch being capable of switching the gamma setting according to a brightness detected by the brightness sensor.

8. The method as claimed in claim 7, wherein the gamma setting adjusting unit switches the transflective liquid crystal display panel to a gamma setting matching the reflection mode when the brightness sensor does not detect light beams emitted by the backlight module.

9. The method as claimed in claim 7, wherein the gamma setting adjusting unit switches the transflective liquid crystal display panel to a gamma setting matching the transmission mode when the brightness sensor detects light beams emitted by the backlight module.

10. A transflective liquid crystal display device, comprising:
a transflective liquid crystal display panel comprising a first substrate, a second substrate, and a liquid crystal layer disposed between the first and second substrates, the second substrate comprising at least one integrated circuit;
wherein a gamma setting adjusting unit is provided to allow the transflective liquid crystal display to switch between gamma settings according to operational modes, the real-life T-curve and R-curve match the ideal curves.
